(19) United States
(12) Patent Application Publication
(10) Pub. No.: US 2012/0173323 A1
(43) Pub. Date: Jul. 5, 2012

(54) DISCOUNTING SYSTEM AND WEBSITE WITH DYNAMIC GROUP PURCHASING DISCOUNT

(76) Inventor: E. Buckley Barlow, South Jordan, UT (US)

(21) Appl. No.: 13/297,950

(22) Filed: Nov. 16, 2011

Related U.S. Application Data
(60) Provisional application No. 61/414,366, filed on Nov. 16, 2010.
(60) Provisional application No. 61/421,415, filed on Dec. 9, 2010.

(51) Int. Cl. G06Q 30/02

(52) U.S. Cl. 705/14.24; 705/14.1; 705/14.35

(57) ABSTRACT

An adjustable discount system adjusts discounts based on system events. The discount system may provide greater or lesser discounts on such events as timing, inventory levels, the number of people committed to purchasing, velocity of sales and acceleration of sales.

### RELATED APPLICATIONS

This application claims the benefit of U.S. Provisional Application Ser. No. 61/414,366, Nov. 16, 2010 and U.S. Provisional Application Ser. No. 61/421,415, filed Dec. 9, 2010.

### THE FIELD OF THE INVENTION

The present invention relates to deal of the day systems, websites and associated hardware and software. More specifically, the present invention relates to a system for providing different discounts offers to purchasers at different times.

### BACKGROUND

Entertainment shopping is becoming a large draw to people. In entertainment shopping, a shopper scours the Internet or other database for a temporary deal which is better than that generally available. One form of entertainment shopping is the use of on-line auctions where consumers attempt to get a product at a price substantially lower than normal. Another form of entertainment shopping is to scour discount websites which offer temporary deals to consumers on electronics, appliances or any of a host of other products of services. Such websites will often provide a product or service at a substantial discount for a limited period of time in order to lure customers to their website and hope to sell other products in addition to the discounted product or service.

While it is common for a store or website to repeatedly discount a product which it desires to get rid of, it is not believed to be common to place an item on a fluctuating sale wherein the price of the item changes repeatedly and may move upward over a desired period of time.

### SUMMARY OF THE INVENTION

It is an object of the present invention to provide an improved system for providing different discounts offers to purchasers at different times.

According to one aspect of the invention, the system may use a timing mechanism to adjust discounts to encourage purchases. For example, a discount may start out large and then be decreased to encourage people to purchase early and to create a sense of urgency.

According to another aspect of the invention, the system may sell a portion of inventory at different discount levels. After a high discount inventory is depleted, a lower discount inventory will be presented to the potential purchaser. Thus, a purchaser would be encouraged to act early to obtain a higher discount.

According to another aspect of the invention, the system may reduce a discount based on sales of the discounted product, with the discount decreasing based on target sales numbers or on the rate at which the product is being sold.

According to another aspect of the invention, the system may monitor purchases and adjust the discount according to the change in the purchasing rate. During times of increasing purchasing rate, the discount may be reduced. While during times of decreasing rate of purchase, the discount may be increased. An optimum pricing point for the current moment may then be reached and maintained until a change in purchasing rate is detected.

According to another aspect of the invention, the system may accept and encourage commitments to purchase at a certain discount level. If the number of people exceeds the required number of purchases for a next discount, a better discount may be given to all who have committed at that level. Bonuses may be given to encourage customers to commit at a lower discount.

These and other aspects of the present invention are realized in a system for providing different discounts offers to purchasers at different times as shown and described in the following figures and related description.

### BRIEF DESCRIPTION OF THE DRAWINGS

Various embodiments of the present invention are shown and described in reference to the numbered drawings wherein:

FIG. 1 shows a flowchart of an adjustable discount system;

FIG. 2 shows a flowchart of an adjustable discount system based in inventory;

FIG. 3 shows a flowchart of an embodiment of a decreasing adjustable discount system based in time;

FIG. 4 shows a flowchart of an embodiment of an increasing adjustable discount system based in time;

FIG. 5 shows a flowchart of an embodiment of a decreasing adjustable discount system based in inventory;

FIG. 6 shows a flowchart of an embodiment of a dynamically adjustable discount system based on purchases over time;

FIG. 7 shows a diagram of modules available in the adjustable discount server system;

FIG. 8 shows a diagram of modules available in an embodiment of the adjustable discount server system;

FIG. 9 shows a screenshot of a website client user interface to the adjustable discount system;

FIG. 10 shows a diagram of a mobile device client user interface to the adjustable discount system;

FIG. 11 shows a diagram of computer hardware connectivity in an adjustable discount system;

FIG. 12 shows a diagram of an adjustable discount system with dynamic group purchasing discount;

FIG. 13 shows a flowchart of an adjustable discount system with dynamic group purchasing discount; and

FIG. 14 shows a screenshot of a website client user interface for an adjustable discount system with dynamic group purchasing discount.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

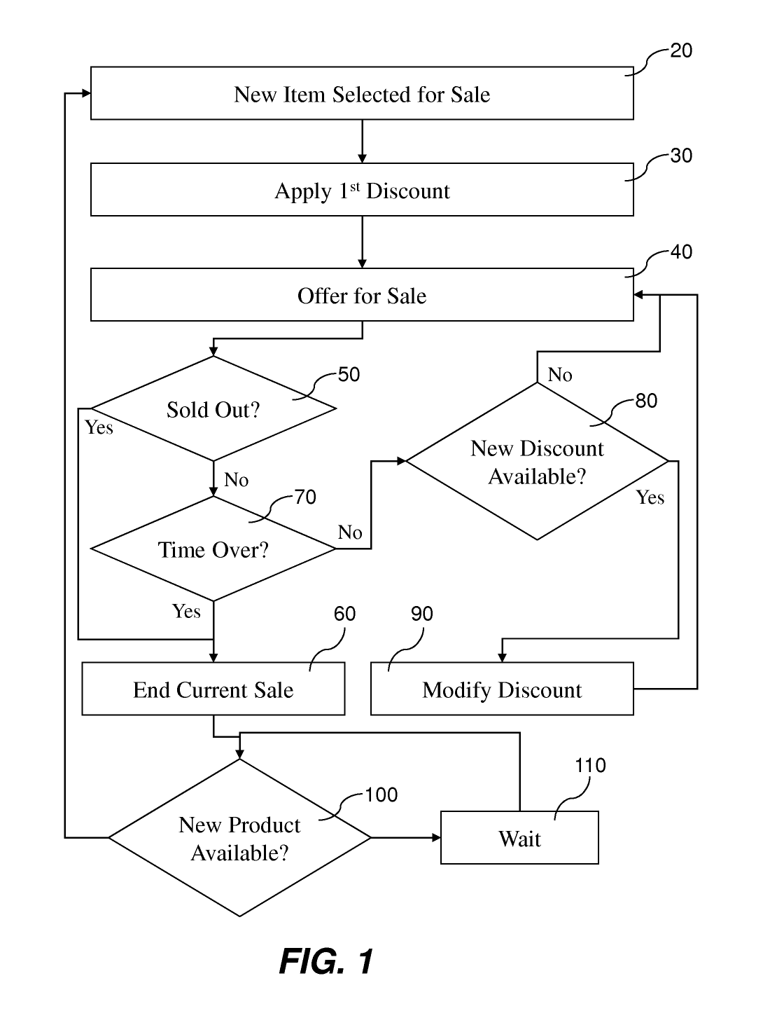

Turning now to FIG. 1, a flowchart of an adjustable discount system is shown. The adjustable discount system may change the discount available to a potential customer based on rules relating the prior actions of the potential customer or other customers to a discount. These actions may be called events, which may include time, inventory levels or sales figures. For example, in some embodiments, the deal may “cool” (receive less of a discount) as more of the product or service is purchased, or as more time passes from when the product was first advertised at discount. In other embodiments, the deal may “warm” (receive a better discount) as time passes. In another embodiment, the discount warms or cools depending on the rate or change in rate of the purchases. In each of these cases, the prior purchase history of other customers, the display time of the discounted item or the waiting time of the current customer affects the current discount offered.

The sales and discount methods discussed herein are typically implemented on a host computer. The computer contains software for presenting deals to users, receiving user sales and payment information, and managing the discount level according to a predetermined sales strategy. The sales offers are typically presented to users via the internet on a sales website. Users may view the sale offers, sales history, or the like on the website, and may enter contact and payment information to purchase the product.

The process may begin with a new item coming up and selected for sale 20. A first discount is applied to the original price of the item 30 (such as the Manufacturer's Suggested Retail Price “MSRP”). The item is then released to be sold 40. If the item sells out 50, the item may be removed from sale 60. If not sold out, but the sale period is over 70, the item may be removed from sale 60. If the sale period is not over 70 and no new discount is available 80, the system may keep the current item discount and sale 40. If there is a new discount available 80, the new discount may be applied 90 and the current item may be offered at the new discount 40.

After the current sale has ended 70 and if a new product is available 100, the new item may be selected for sale 20. Otherwise, the system may wait 110 until a new product is available 100.

Different mechanisms may be employed to allow a customer to purchase an item at the price offered. This may be through an item reservation system that reserves a part of inventory for a time, a timeout mechanism that gives a person a certain time to complete a purchase once selected, a first come first served system, an estimated inventory reserve or other purchase process.

While the discussion may center on items, goods, products and customers for illustrative purposes, it should be recognized that the adjustable discount system may also apply to services and clients. The system may also be used to order services from potential clients. Thus any reference to items, goods, products, customers and similar references should be considered also a reference to services, clients and similar references.

It will be appreciated that the system described herein can be used to push consumer's action either toward a purchase or toward additional visits to a website. By having the price escalate after a period of time, the consumer may be more willing to purchase on the spot to lock in the best price. By changing the discount up and down, the consumer is urged to make multiple visits to the website in an effort to secure the best price. Likewise, the price can be driven by consumer reaction, with rapid sales moving the discount down and slow sales causing the discount to increase.

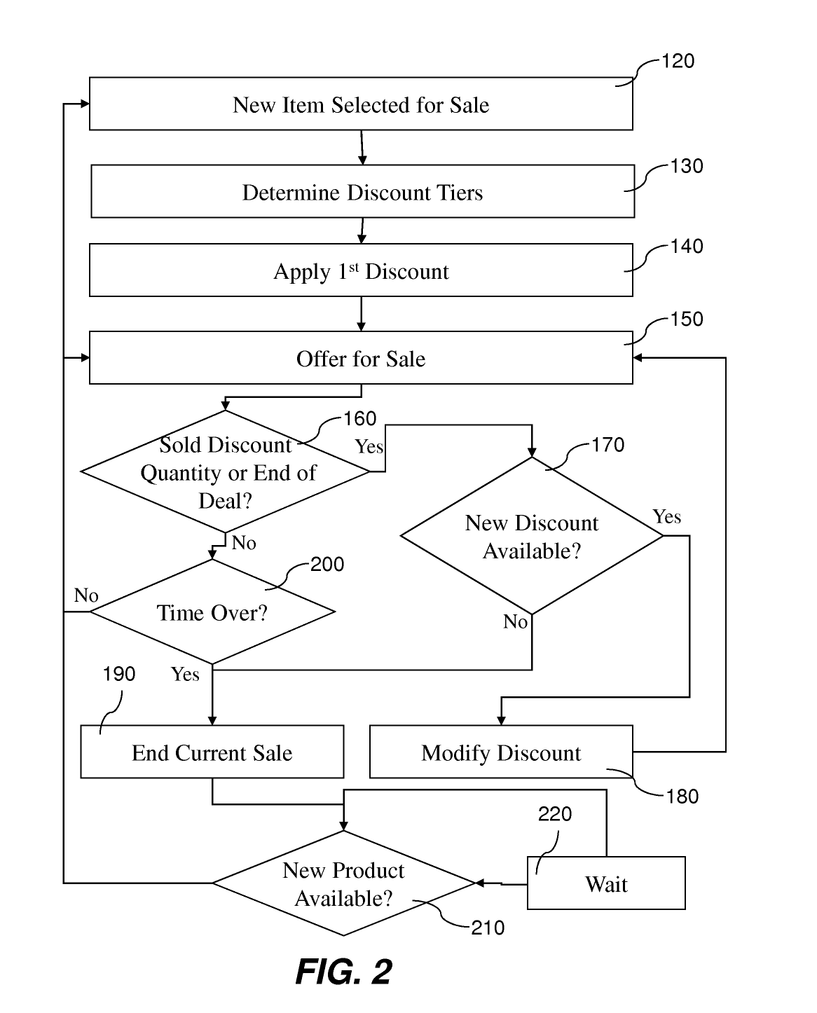

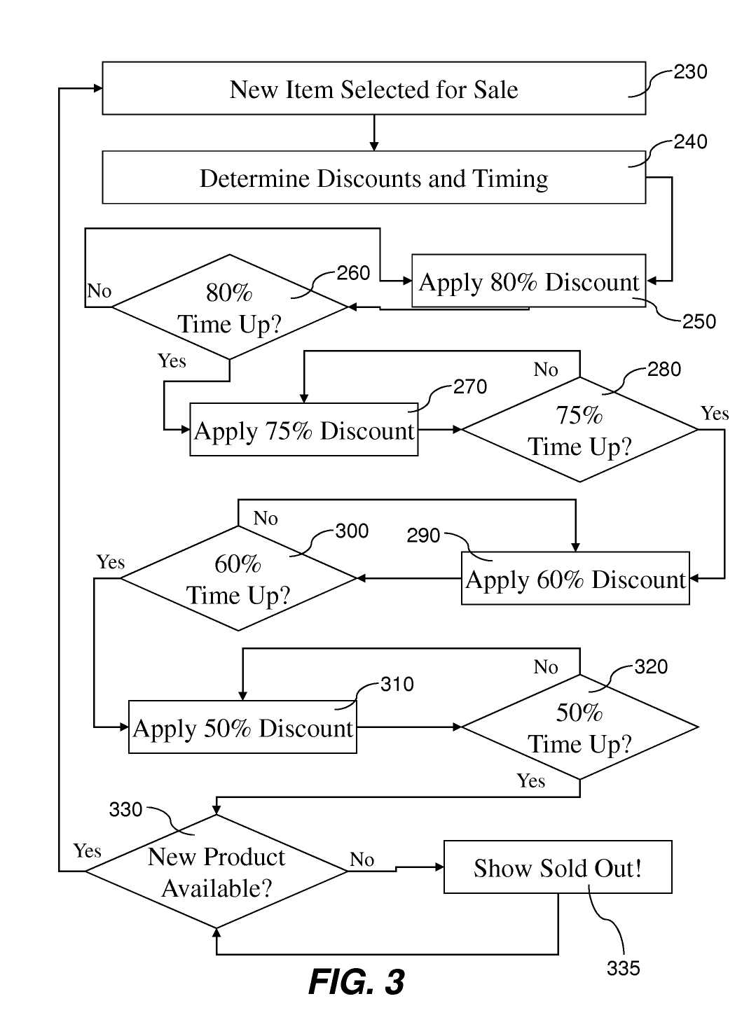

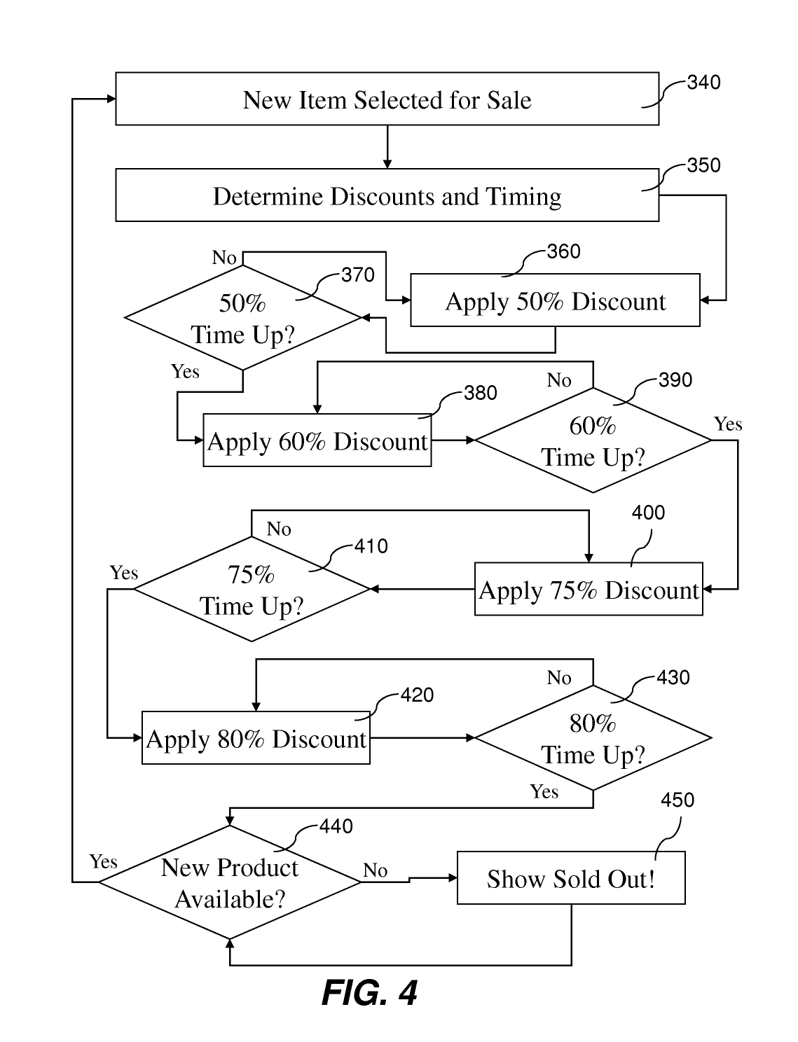

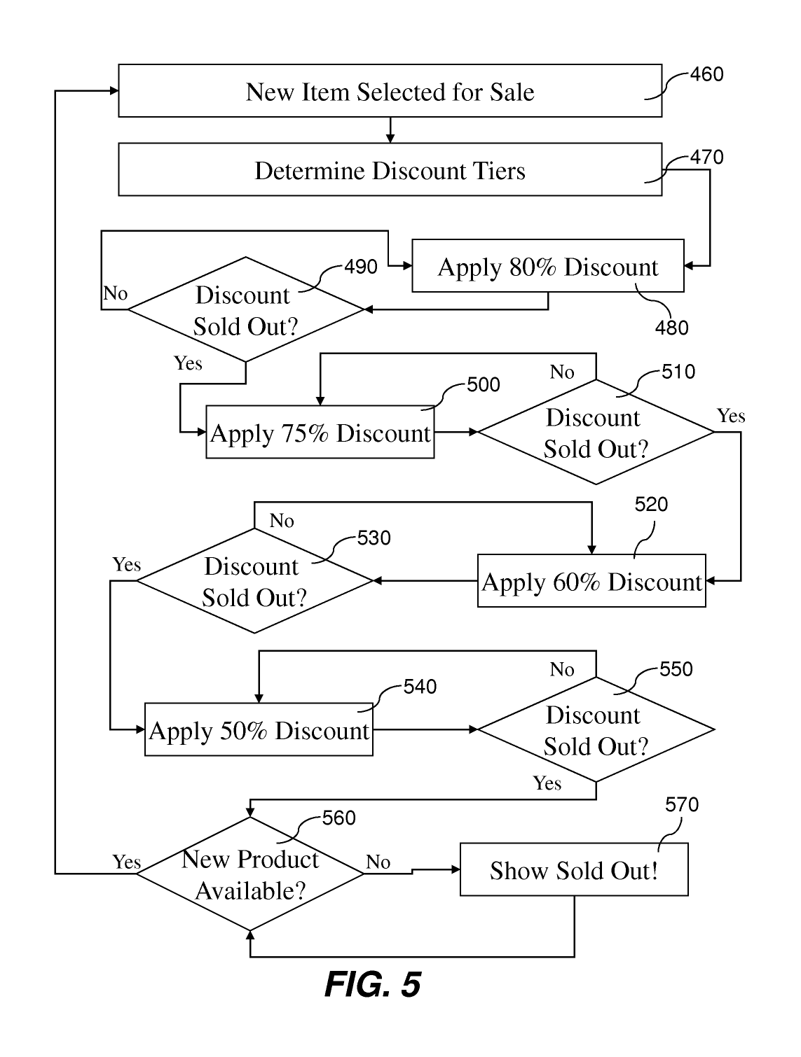

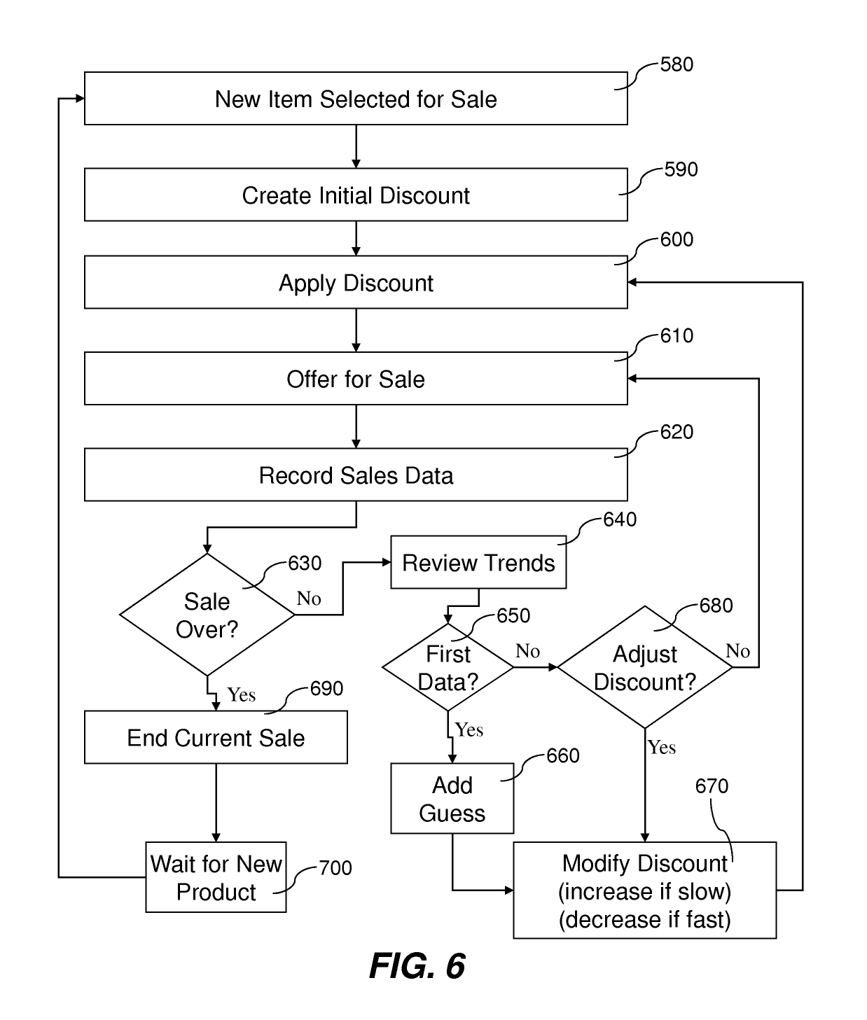

Thus, the adjustable discount system may be tied to various actions or inaction of potential customers as individuals or collectively. In FIGS. 2 through 6, more specific applications of an adjustable discount system are shown. In FIGS. 2 and 5, an adjustable discount system ties a discount to inventory levels. In FIGS. 3 and 4, an adjustable discount system ties a discount to purchase timing. In FIG. 6 a dynamic discount system ties to sales over time.

Turning now to FIG. 2, a flowchart of an adjustable discount system based in inventory is shown. An administrator selects an item for sale 120. The inventory is separated into discount tiers 130. The system may then apply the first discount 140 and offer the item for sale 150. If the quantity of inventory allocated to the current discount tier has been sold or any prescribed time limit for the tier has expired 160, the system may check for the next available discount tier 170. If the next discount tier is available 170, the system may modify the discount available to potential customers 180 and offer the new discount tier for sale 150. However, if no discount is available 170, the system may end the current item sale 190.

However, if the quantity of inventory allocated to the current discount tier has not been sold and any prescribed time limit for the tier has not expired 160, the system may check to see if the overall sale of the item has exceed a time limit of the sale 200. If sale has exceeded the time limit, the system may end the current item sale 190. If not, the system may continue to sell the current item at the current discount 150.

Once the system has ended the sale 190, the system may check to see if a new product is available 210. If not, the system may choose to wait for a new product to be available 220. Once the new product is available, the system may begin again by selecting the new item for sale 120.

A purpose of separating inventory into discount tiers may be to offset a larger discount to some inventory by a lesser discount to another part of inventory. A larger discount generates more excitement among shoppers, and encourages shoppers to purchase before a discount goes away. As conversion is generally measured as a percent of visitors, generating excitement among shoppers may create more visitors and therefore more conversions. Thus, a smaller profit margin on a part of inventory may be made up by a larger profit margin on other inventory and/or higher store traffic.

The separation of the inventory into discount tiers may be manual or computer aided. The system may have a module capable of suggesting and/or automatically separating the inventory into discount tiers. The system may be able to look at a past history of sales and suggest and/or implement a more optimum discount tier based on historical information and analytics. An administrator may also be able to select desired discount tiers and/or override any system choices.

Turning now to FIG. 3, a flowchart of an embodiment of a decreasing adjustable discount system based in time is shown. In the embodiment shown, discount levels of 80%, 75%, 60% and 50% are chosen. Each discount may have a period of time for which they may be available. The periods may be evenly spaced over 24 hours. It may also be desirable to put the larger discounts for a shorter period of time. In one embodiment, each discount lasts roughly for twice as long as the discount just larger than itself. For example, a four discount tier may have the largest discount last for 1.6 hours, a second largest discount for 3.2 hours, a third discount for 6.4 hours and a fourth discount for 12.8 hours.

A new item is selected for sale 230. Discounts and the timing of the discounts may be set up in the system 240. A first discount of 80% is applied for the item on sale 250. Once the time for the 80% discount is up 260, the next discount of 75% is applied 270. Similarly, once the time for the 75% discount is up 280, the next discount of 60% is applied 290. Once the time for the 60% discount is up 300, the next discount of 50% is applied 310. Once the time for the 50% discount is up 320, the system checks to see if a new product is available 330. If not, the system may display information indicating the item has sold out 335 until a new item is available 330. If the inventory has sold out during any of the discount phases, the system may go directly to 330.

Turning now to FIG. 4, a flowchart of an embodiment of an increasing adjustable discount system based in time is shown. The system from FIG. 3 may also be used in an increasing discount situation.

A new item is selected for sale 340. Discounts and the timing of the discounts may be set up in the system 350. A first discount of 50% is applied for the item on sale 360. Once the time for the 50% discount is up 370, the next discount of 60% is applied 380. Similarly, once the time for the 60% discount is up 390, the next discount of 75% is applied 400. Once the time for the 75% discount is up 410, the next discount of 80% is applied 420. Once the time for the 80% discount is up 430, the system checks to see if a new product is available 440. If not, the system may display information indicating the item has sold out 450 until a new item is available 440. If the inventory has sold out during any of the discount phases, the system may go directly to 440.

While FIGS. 3 and 4 show retreating and escalating discounts, respectively, it will be appreciated that the discounts need not follow a trend. For example, a discount of 50% could be followed briefly by a discount for 80 percent, followed by a discount for 40%. By regulating the changes in discounts, improved sales flow can be accomplished.

Turning now to FIG. 5, a flowchart of an embodiment of a decreasing adjustable discount system based in inventory is shown. Instead of timing of discounts as in FIGS. 4 and 5, the inventory may be separated into discount tiers and the discount adjusted as each tier sells out.

A new item is selected for sale 460. Discounts and the timing of the discounts may be set up in the system 470. A first discount of 80% is applied for the item on sale 480 for a given inventory, e.g. 100 pieces. Once the inventory for the 80% discount is sold 490, the next discount of 75% is applied 500 for a second inventory amount, e.g. 200 pieces. Similarly, once the inventory for the 75% discount is sold 510, the next discount of 60% is applied 520 for a third inventory amount, e.g. 400 pieces. Once the inventory for the 60% discount is sold 530, the next discount of 50% is applied 540 for a fourth inventory amount, e.g. 1000 pieces. Once the inventory for the 50% discount is sold 550, the system checks to see if a new product is available 560. If not, the system may display information indicating the item has sold out 570 until a new item is available 560. If the sales event runs out of time during any of the discount phases, the system may go directly to 560.

It should be noted that while the flowcharts discuss discounts going up or down, the discounts may be adjusted for a number of factors. For example, the discounts may be adjusted up or down according to the purchase habits of consumers.

Similarly, the discounts may be adjusted to peak during a desired period during the day. Thus early adopters may choose to buy early to avoid the product selling out. Big discounters may wait until the peak discount. Late corners or “me too” purchasers may choose to buy at the end of day because of other purchasers.

On the other hand, discounts may be adjusted to a minimum (or valley) during a portion of the sale. Early adopters may be encouraged to purchase with a deep discount. People following the early adopters and fearing a sellout of the item may purchase during the minimum period. As the end of the sale nears, the remaining inventory may be cleared out by a deeper discount.

In other cases a discount over time may be shaped like waveform or a sawtooth, with random, big discounts followed by little discounts. Traffic may be spurred by people waiting for the next big discount, which may include unannounced, hinted at, displayed or trending discounts—causing potential customer interest.

Depending on the market, a discount strategy of high to low, low to high, peak, valley or multiple peaks or valleys, or other waveform may be desirable. This information may be gleaned after some experiments and examining sales data and/or analytics.

Turning now to FIG. 6, a flowchart of an embodiment of a dynamically adjustable discount system based on purchases over time is shown. A new item may be selected for sale 580. An initial discount may be created 590 by an administrator or the system. The discount may be applied to the original price of the item 600. The item may be then placed on sale 610. Data, such as sales information that may include volume and volume over time, may be recorded 620. The system may check to see if the sale is over 630 before examining the trends in the data recorded 640. If the data returned is a first point in the dataset 650, the system may include a guess as to performance 660 if the discount is adjusted 670, as the system may not have adequate information from the first datapoint. If the data has sufficient historical information 650, the system may determine a discount adjustment 680 and modify the discount 670. The modified discount may then be applied to the sale of the item 610. Once the sale is over due to time or inventory or some other factor 630, the system may end the sale 690 and wait for the next product 700.

The steps discussed in FIGS. 1 to 6 represent illustrative embodiments and discussion of an adjustable discount system. It should be recognized that some steps may be omitted, processed in parallel, moved within the process, split, split and moved to different parts of the process and otherwise modified to suit a particular system and/or market.

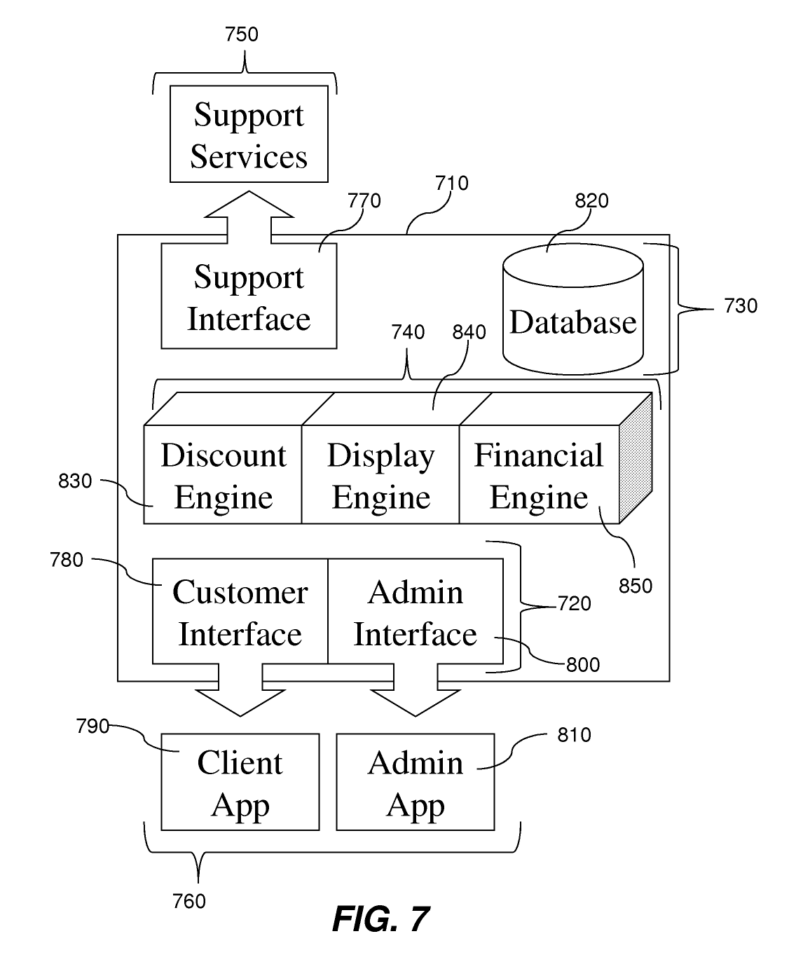

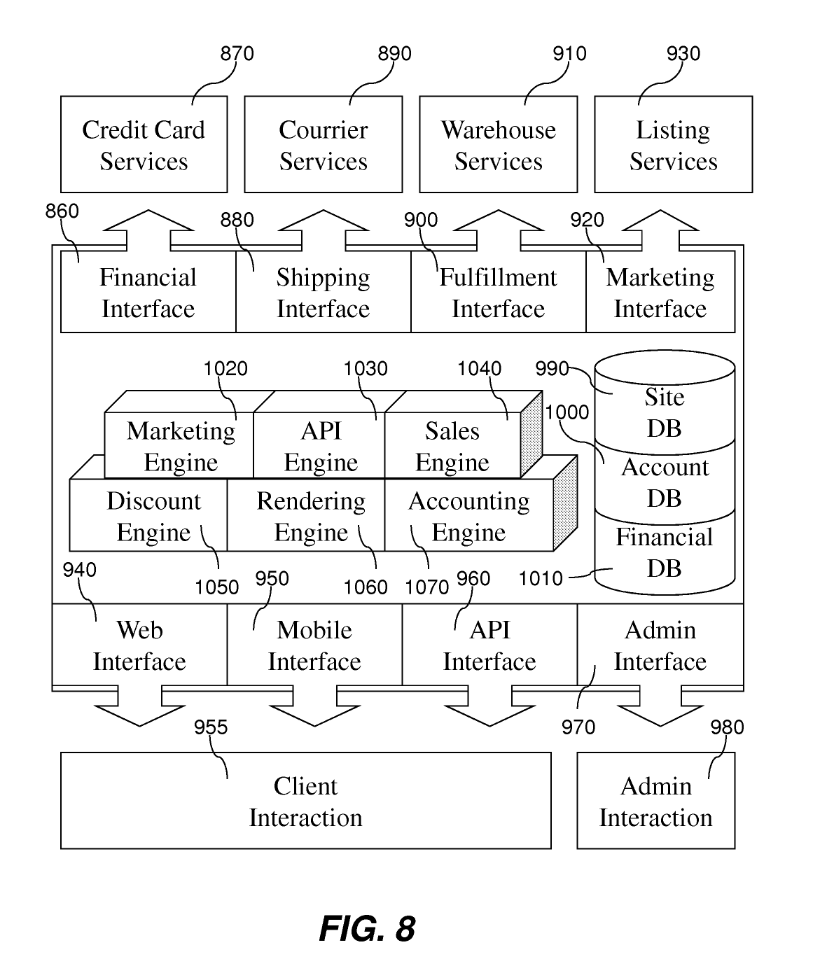

The adjustable discount system may be composed of components or modules to facilitate its functionality. While specific modules may be discussed for illustration, it should be recognized that this functionality may be further divided or combined in lines of code, modules, functions, routines, processes, classes, objects, plugins, programs, processors, computers, services, networks and other processing instructions or systems. In FIGS. 7 and 8, an adjustable discount system's structure may be discussed in terms of modules and functionality.

Turning now to FIG. 7, a diagram of modules available in the adjustable discount server system 710 is shown. The adjustable discount server system 710 may include interfaces 720, storage 730 and engine modules 740. The system may also be in communication with external services 750, clients and administration systems 760.

The adjustable discount server system 710 may include interfaces and/or application programmer interfaces (API's) to external systems and their API's. These interfaces may include a support interface 770 to communicate with and allow external services 750 to support and/or enable functionality within the server system. A customer interface 780 may communicate with customer facing applications 790 and/or renderings, including account services. An administrative interface 800 may allow an administrator access 810 to website changes, discount settings, analytics and other information receiving or sending.

The adjustable discount server system may also contain storage 730. This storage may include at least one database 820, media, RAM, discs, cloud storage, network storage, hard drive or other storage medium or mechanism. Website, customer and settings information, among other information, may be stored by the adjustable discount server system to aid in system tasks. System tasks may include logging in, account services, administration, logging out, and adding new items.

The adjustable discount server systems 710 may contain several processing modules or engines 740. A discount engine 830 may prepare and track discounts, including reviewing sales information from the database 820. A display engine 840 may process current database 820 information and render it for display through a client interface, such as a webpage displaying an item at a discount. A financial engine 850 may prepare and track orders, process payments and communicate and process financial transaction information with the database 820.

Turning now to FIG. 8, a diagram of modules available in an embodiment of the adjustable discount system is shown. More specific modules are shown that may include interfaces, storage and engines.

The adjustable discount system may have interfaces that aid in the communication with external systems and their API's. A financial interface 860 may connect with financial services, such as with a credit card processor 870 to aid in payment. A shipping interface 880 may aid in the fulfillment and estimates of shipping through communication with courier services 890 and their API's. A fulfillment interface 900 may communicate with warehousing services to print pick lists and/or communicate drop shipments 910. A marketing interface 920 may communicate with other information systems, including providing information to deal of the day listing services 930, google adwords listings and/or press release information. A web interface 940 may provide a client 955 facing web page and API's. A mobile interface 950 may provide an API for client facing mobile applications. An API interface 960 may provide an interface for applications and/or systems to access that accept standard formats or services, including XML, HTML, REST, SOAP, WDSL, JSON and other information bearing files and services. An administrator interface 970 may provide access to an administrative page 980 and/or API's for managing the adjustable discount system.

The adjustable discount system may have storage to provide information to the interfaces and engines. The storage types may be similar to those described in FIG. 7. The storage may be further subdivided into site database modules 990, account database modules 1000 and financial database modules 1010. The site database module 990 may include information relating to the operation of the system, including discount information, settings, item information, analytics information and other parameters, information and files. The account database 1000 may manage storage relating to purchasers or potential purchasers and their customizations and data. A financial database 1010 may contain sales information, invoices, and other financial related data. In one embodiment, a security model allows only authorized modules to access certain databases. For example, the marketing interface may not have permission to access the financial database.

The adjustable discount system may have engines, processing modules or business logic to aid in the operation of the system, all of which are referred to here as engines. The system may use a marketing engine 1020, API engine 1030, sales engine 1040, discount engine 1050, rendering engine 1060 and accounting engine 1070. The marketing engine 1020 may process requests from a marketing interface, pull information from a database, process the information and send the answer back through the marketing interface. The API engine 1030 may process requests based on API calls from an interface, pull information from a database, process the information and return a result. The sales engine 1040 may manage the purchase process, including logging in, providing personal information, purchasing an item and/or shipping the item. The discount engine 1050 may contain the logic for timing the discounts, including both static timing discounts, static inventory discounts and dynamic purchase over time discounts. A rendering engine 1060 may provide the various client and administrator API's and interfaces with information, skins and color schemes, such as time remaining on a discount, amount sold, analytics, session information and purchase links. An accounting engine 1070 may control the secure processing of sensitive and financial information, including communication with the financial interface, shipping interface and financial database.

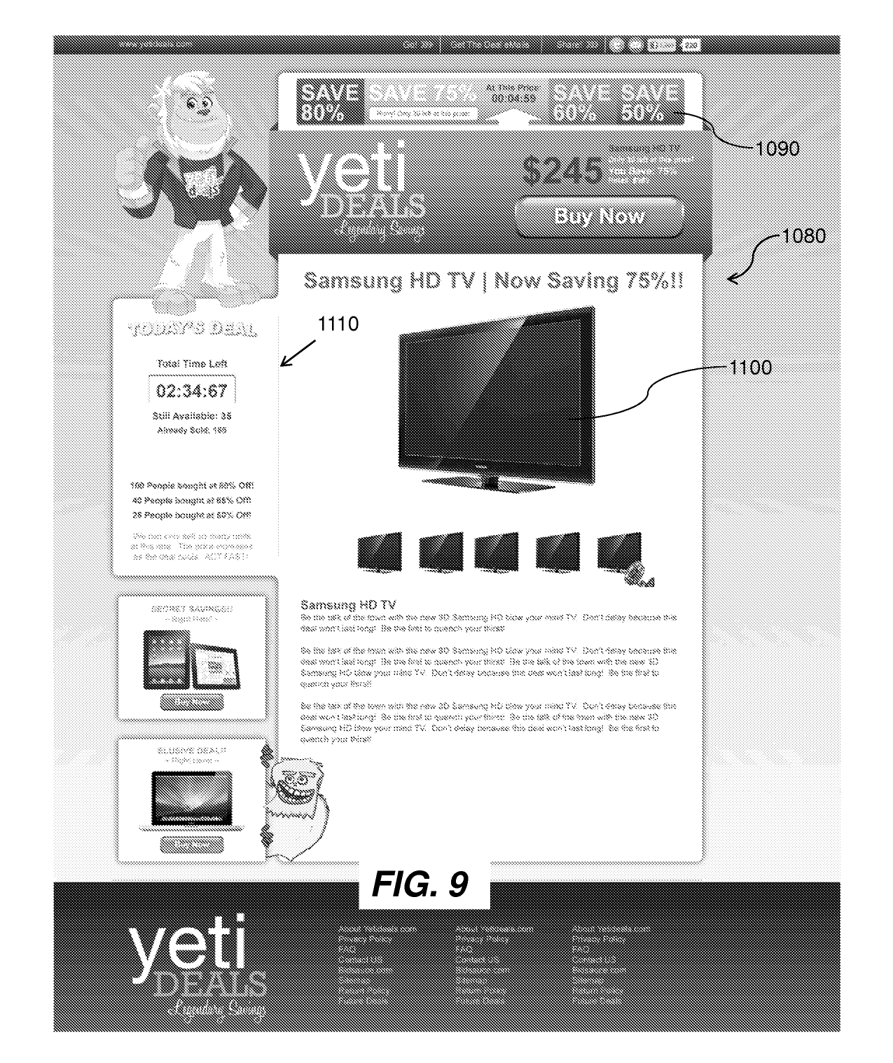

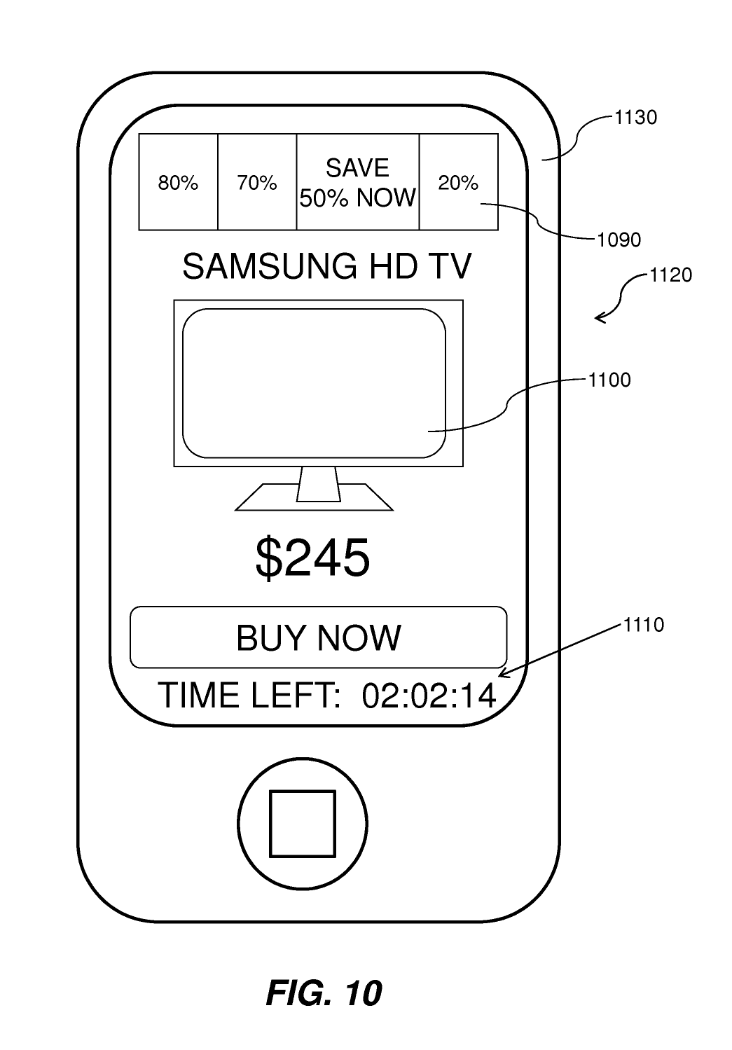

The adjustable discount system may interact with users through various channels. In FIGS. 9 and 10, illustrations of potential user interfaces are shown. While specific examples may be shown for illustration, the principles taught may be applied in other instances of interaction and/or interfaces.

Turning now to FIG. 9, a screenshot of a website client user interface 1080 to the adjustable discount system is shown. The website 1080 may include a current discount information bar 1090, an item on sale 1100 and information relating to the sale 1110.

The discount bar 1090 (also known as a slider) may relay information about the discounts. The discount bar may identify past, current and future discounts. It may be colored to indicate the importance of the discount relative to other potential discounts. A call to action and statistics may be used to encourage purchases.

The item on sale 1100 may include pictures, descriptions and other relevant information. The pictures may display the product in different positions and highlight different areas of the item. The description may highlight the discount, provide useful information and a call to action, including a call to purchase the item.

Information about the sale 1110 in the form of a sales statistics section may be pulled from the adjustable discount system to aid in pushing a purchasing mentality. For example, a deal timer along with purchased and current stock information may aid in showing a pressing need to purchase or losing the opportunity for a great deal.

Turning now to FIG. 10, a diagram of a mobile device client user interface 1120 to the adjustable discount system is shown. Similar to FIG. 9, the information may be simplified and/or paged to display on a mobile device 1130. The mobile device may access this information through an application receiving information, such as XML through SOAP, or through a special page delivered to mobile devices, such as by a webserver serving HTML.

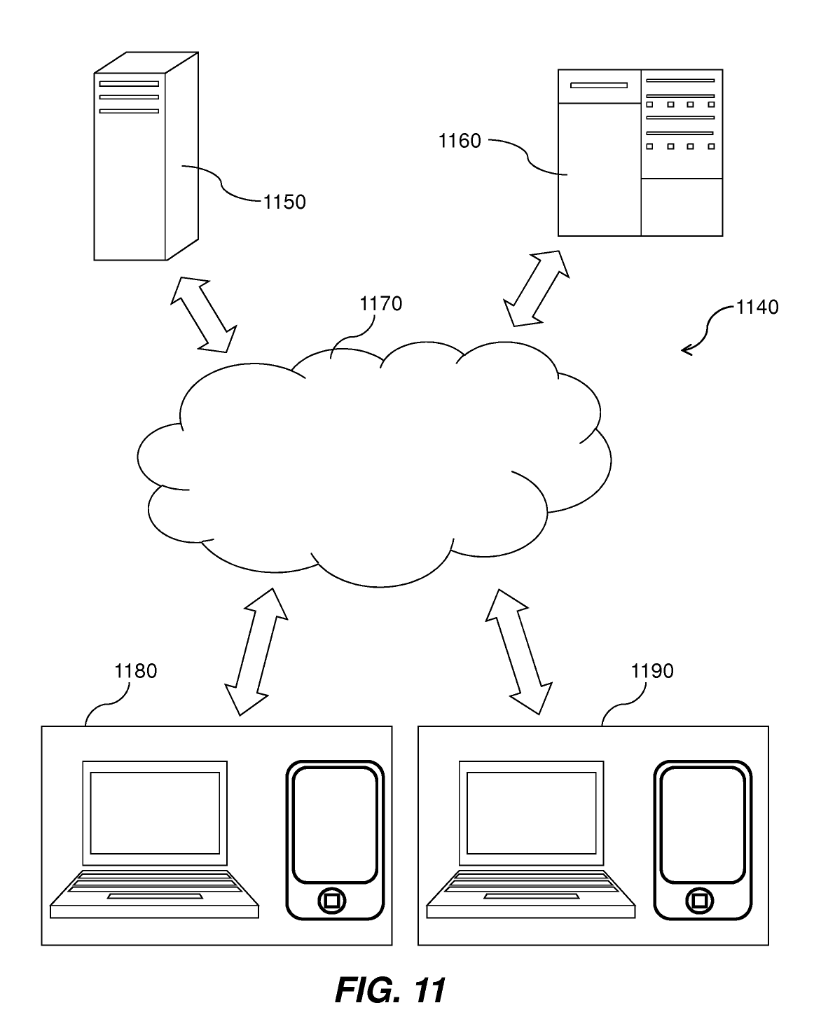

Turning now to FIG. 11, a diagram of computer hardware connectivity 1140 in an adjustable discount system is shown. A discount server system 1150 may communicate with support servers 1160 through a network, such as the internet 1170. The discount server system 1150 may also communicate with client devices 1180, such as a computer or mobile device through a network as well. Similarly, the discount server system may communicate with administrative devices 1190 through a network.

While the network is shown to be the same in FIG. 11. It should be recognized that separate networks may be employed and/or desirable. For instance, it may be desirable to have the credit card payment system on a separate network or a virtual private network.

While the changing prices used in accordance with the present invention are advantageous in liquidating inventory of a particular product, they can also be helpful in determining the proper pricing for a product in order to maximize profitability. For example, if a product were discounted by 10% and showed brisk sales, it would indicate that the product is already reasonably priced. If, however, substantial discounts are needed to obtain sales, then it is apparent that the product may be seen are over-priced. Additionally, by adjusting the discounts based on sales volume, a maximized profit curve can be obtained. For example, if a 20% price cut takes out 70% of the profit in an item, but only results in a 30% increase in sales, it may be determined that a 10% price cut is better as it may take slightly longer to move the inventory, but the profit margin per unit will be substantially higher. Any remaining inventory after a desired time period can then be disposed of by offering deeper discounts.

The discounting system and method described herein can also be effective at drawing traffic to a website. For example, a product could be offered with a discount of 30%. The website may also indicate that 40% and 60% discounts will be available. The rule in the discount engine could designate 200 units to be sold in 50 unit increments receive the 60% discount, and 1000 units to be sold in 100 unit increments are to be sold at the 40% discount. Periodically throughout the day, the discount engine would then put the 40% discount and the 60% discount increments up until each had sold. Thus, consumers who really want the higher discount will check back frequently during the day to see if the higher discounts are available. Such could be used in conjunction with other advertised deals to ensure that they are seen by large numbers of potential customers.

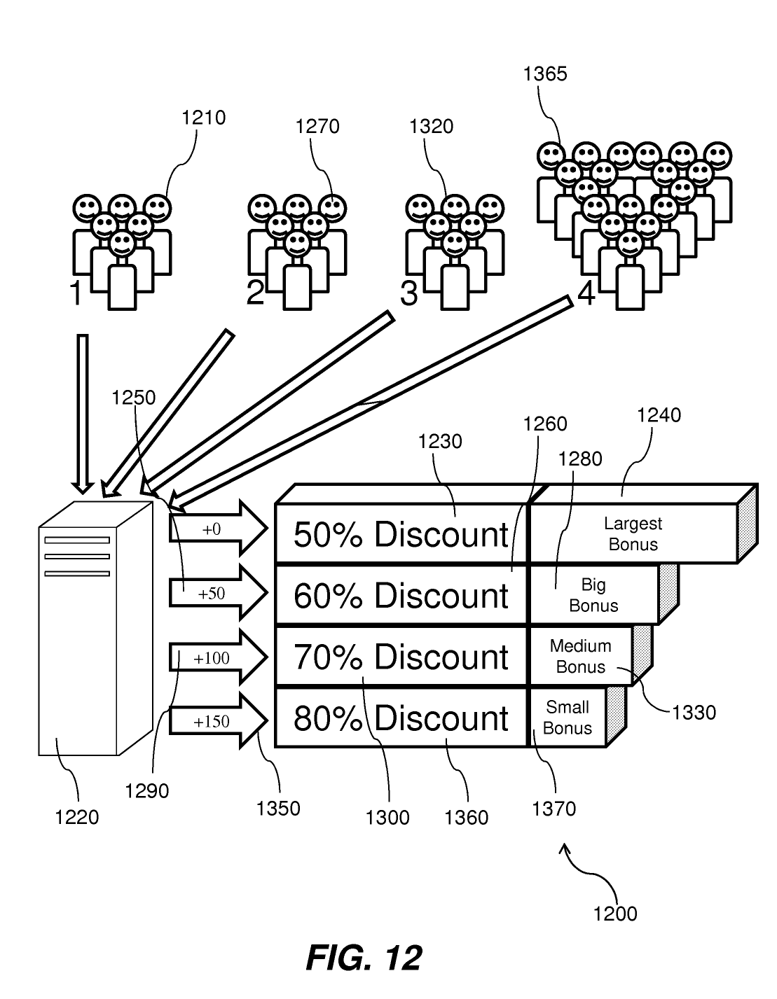

Turning now to FIGS. 12 to 14, an adjustable discount system with dynamic group purchasing discount is shown. As more people commit to purchasing an item for sale, the discount gets progressively larger. Thus, a popular item may be more heavily discounted than an unpopular item. By making the system dynamic according to the number of purchasers, the system may be able to balance profit margin with volume while encouraging a fun entertainment shopping experience.

Turning now to FIG. 12, a diagram of an adjustable discount system with dynamic group purchasing discount 1200 is shown. As a first group of customers 1210 may commit to purchase an item through a computer interface 1220, they may be offered a lowest discount 1230 with a best first bonus 1240. Once the first group 1210 meets and/or exceeds the required number of commitments 1250, the first group will automatically receive a better second discount 1260 and keep their first bonus 1240.

The better second discount 1260 may be offered to more potential customers. A second group of customers 1270 may commit to purchase an item through a computer interface 1220 for the second discount 1260 with a second bonus 1280 that may be less than the first bonus 1240. Once the second group 1270 meets and/or exceeds the required number of commitments 1290, the first group 1210 and second group 1270 may automatically receive a better third discount 1300 and keep their original bonus.

The better third discount 1300 may be offered to more potential customers. A third group of customers 1320 may commit to purchase an item through a computer interface 1220 for the third discount 1300 with a third bonus 1330 that may be less than the second bonus 1280. Once the third group 1320 meets and/or exceeds the required number of commitments 1350, the first group 1210, second group 1270 and third group 1320 may automatically receive a better fourth discount 1360 and keep their original bonus.

Eventually, the system may arrive at a final discount, such as the fourth discount 1360 in FIG. 12. New commitments by new customers 1365 may be at the heightened discount and may or may not receive a final bonus 1370.

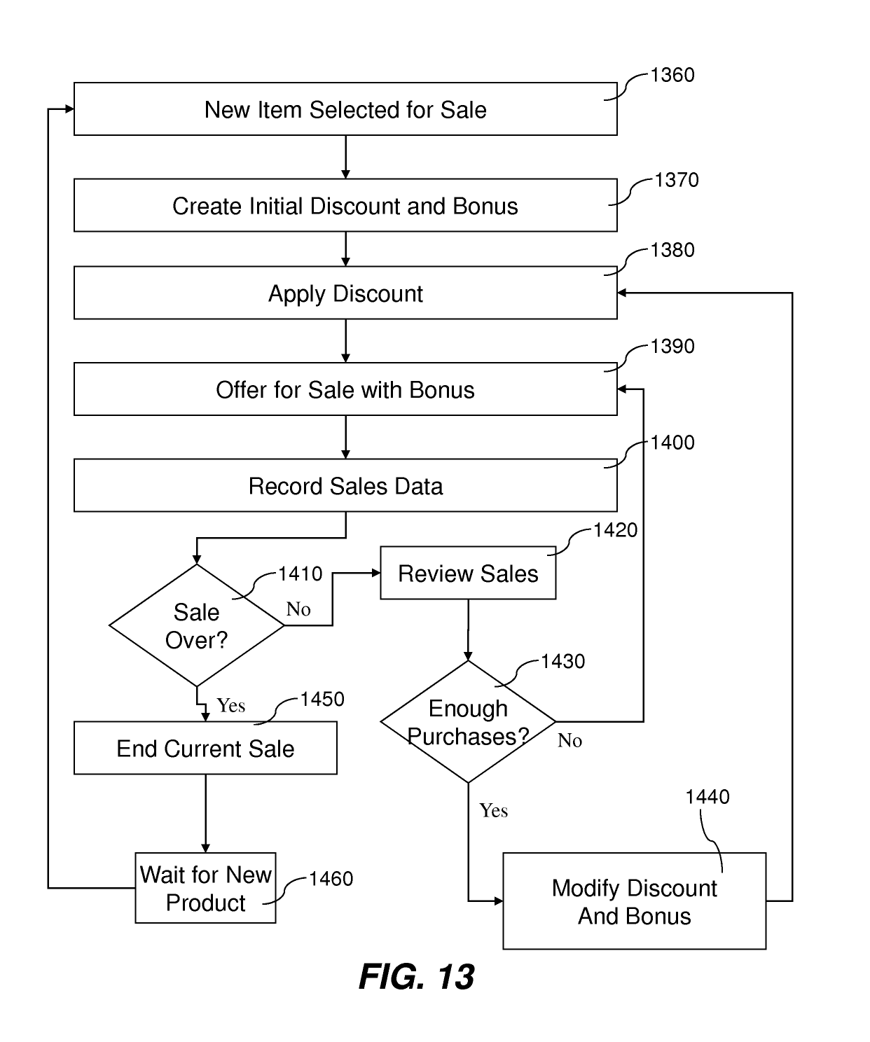

Turning now to FIG. 13, a flowchart of an adjustable discount system with dynamic group purchasing discount is shown. An item may be selected for sale 1360 and given an initial discount and bonus for initial commitments 1370. The discount may be applied 1380 and the item offered for sale with the bonus 1390. The sales may then be monitored 1400. If the sale is not over 1410, the sales may be reviewed 1420. If there have been enough commitments to purchase 1430, the discount and bonus may be modified 1440 and the new discount applied 1380 and offered for sale with the new bonus 1390. If there have not been enough commitments to purchase 1430, the sale may continue as is 1390. If the sale is over 1410, then the current sale may be ended 1450 and the system may wait for a new product to sell 1460.

The waiting for new product may include waiting for a period of time, waiting for further input, waiting for a notification, or other basis for automatic or manual conditions to continue.

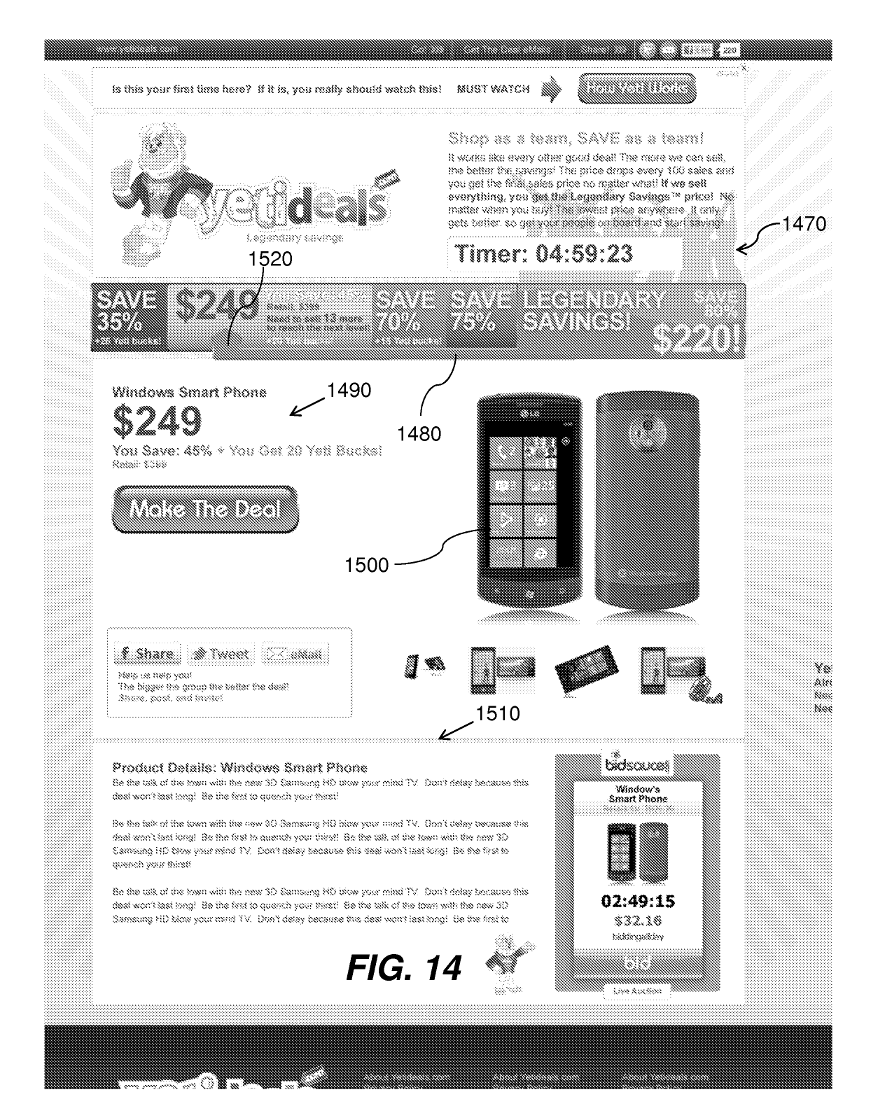

Turning now to FIG. 14, a screenshot of a website client user interface for an adjustable discount system with dynamic group purchasing discount 1470. The system may include a group discount slider 1480, a purchasing block 1490, multimedia block 1500, and product information block 1510.

The group discount slider 1470, also known as a legendary savings bar, may show potential purchasers the benefits that are available and possible through the system. In the group discount slider 1470 shown, enough people have committed to the purchase that a second discount has become available at 40%, above the 35% original discount. This is shown by the arrow 1520 underneath the discount and bonus information. If enough people commit to the purchase again, as shown as 13 more by the graphic, a new discount of 70% will open. This may repeat until the final discount at Legendary Savings is available.

A purchasing block 1490 may include information and processes to aid in the commitment to purchase. This may include the price, a link to the commitment page, information about the discount and bonus and the normal retail price.

A multimedia block 1500 may include information about the product on sale, the sales service or entertaining content. In the multimedia block 1500 shown, a user may select different screenshots and/or videos about the product.

A product information block 1510, may provide further information and/or entertainment about the product. In the product information block 1510 shown, more information about the product and benefits are provided.

It should be recognized that this adjustable discount system may work in conjunction with other systems. For instance, the adjustable discount system may be placed in a subscription service where users pay a fee to view and/or participate in the discounts.

It should be recognized that while specific numbers have been used in the discussion of various embodiments, other numbers may be used. Discounts may be different from the 80%, 75%, 60% and 50% discussed herein. Similarly, the inventory levels may be different. Each product may be viewed in terms of the profit margin and overall sales potential to maximize a desired statistic, such as overall profit, visits, or other desired outcome.

There is thus disclosed an improved adjustable discount system. It will be appreciated that numerous changes may be made to the present invention without departing from the scope of the claims.

What is claimed is:

1. An adjustable discount system comprising:
a support interface providing communication with external services;
a customer interface providing instructions for an electronic display of an item for sale and a current discount;
a discount engine, wherein the discount engine is programmed to change the discount according to rules specified by an administrator;
an administrator interface, wherein the administrator configures rules for discounts;
a database, wherein the database stores information about the rules and discount.

2. The system according to claim 1, wherein the discount engine is programmed to reduce the discount based on time thresholds.

3. The system according to claim 2, wherein the customer interface displays the amount of time left until the discount is adjusted.

4. The system according to claim 2, wherein the customer interface displays the different discounts which will be available.

5. The system according to claim 1, wherein the discount engine verifies the inventory of discounted item available and adjusts the discount based on the inventory.

6. The system according to claim 1, wherein the discount engine is programmed to increase discounts if sales have been below a desired threshold over a given time and to decrease discounts is sales have been above a desired second threshold over a given time.

7. A method of adjusting a discount provided to a potential customer during a discounting period, the method comprising the steps of:
selecting an item for sale;
configuring a rule for applying a plurality of discounts;
selecting an initial discount;
offering the item for sale at an initial discount;
detecting an event according to the rule;
selecting a second discount according to the rule; and
offering the item for sale at a second discount.

8. The method according to claim 7, wherein the rule comprises a time threshold and wherein a different discount is applied to the item for sale with the expiration of each time threshold until the discounting period has terminated.

9. The method according to claim 7, wherein the rule comprises an adjustment based on sales volume and wherein the method comprises increasing the discount if sales are below a desired threshold and decreasing the discount if sales are above a desired second threshold.

10. The method according to claim 7, wherein the method comprises applying a varying levels of discounts to move the price of the item for sale up and down during the discounting period.

11. The method according to claim 7, wherein the rule comprises granting a lower discount to all current and future purchasers at the sale, once a certain number of people have agreed to purchase the item.

12. The method according to claim 11, further comprising providing a larger bonus for earlier purchasers.

13. A display page providing an adjustable discount comprising:
a discount information bar, comprising a list of potential discounts;
an item for sale;
a purchasing link; and
a sales statistics section.

14. The display page of claim 13, wherein the display page identifies a plurality of different discount levels which will be available.

15. The display page of claim 13, wherein the display page is disposed in communication with a discount engine and wherein the display page changes in response to the occurrence of events monitored by the discount engine.

16. The display page of claim 13, wherein the discount information bar displays a current discount.

17. The display page of claim 16, wherein the discount information bar changes the current discount based on the number of people who have committed to purchase the item.

18. An adjustable discount system comprising:
a discount server;
a network;
a support service in communication with the discount server over the network;
a client device in communication with the discount server over the network; and
a administrative device in communication with the discount server over the network;
wherein the discount server changes the discount available to the client device based on an event.
